(19) United States
(12) Patent Application Publication
(10) Pub. No.: US 2012/0278120 A1
(43) Pub. Date: Nov. 1, 2012

(54) CROSS-SCHEDULE DEPENDENCIES USING PROXY TASKS

(75) Inventors: Matthew J. Insko, Milford, OH (US); Niranjan K. Iyer, San Diego, CA (US)

(73) Assignee: SIEMENS PRODUCT LIFECYCLE MANAGEMENT SOFTWARE INC., Plano, TX (US)

(21) Appl. No.: 13/240,463

(22) Filed: Sep. 22, 2011

Related U.S. Application Data
(63) Continuation of application No. 61/480,527, filed on Apr. 29, 2011.

(51) Int. Cl. G06Q 10/06; G06Q 10/10

(52) U.S. Cl. 705/7.21

(57) ABSTRACT

Product Data Management systems, methods, and mediums. A method includes receiving a first schedule. The first schedule includes at least a first task. The method includes creating a proxy task in a second schedule. The proxy task corresponds to and is a substantial copy of the first task. The method can include creation of a dependency between the proxy task in second schedule and another task in the second schedule. The method includes storing the second schedule.

### CROSS-REFERENCE TO RELATED APPLICATION

This application claims the benefit of the filing data of U.S. Provisional Patent Application 61/480,527, filed Apr. 29, 2011, which is hereby incorporated by reference.

### TECHNICAL FIELD

The present disclosure is directed, in general, to computer-aided design, visualization, and manufacturing systems (“CAD” systems), product lifecycle management (“PLM”) systems, program and project management systems, and systems that manage data for products and other items (individually and collectively, product data management (“PDM”) systems)

### BACKGROUND

PDM systems can aid users in creating, managing, and executing project schedules, among other functions, including the scheduling of tasks.

### SUMMARY OF THE DISCLOSURE

Various disclosed embodiments relate to systems and methods for managing cross-schedule dependencies using proxy tasks, and in particular, in PDM systems configured to perform processes as described herein.

Various embodiments include PDM systems, methods, and mediums. A method includes receiving a first schedule. The first schedule includes at least a first task. The method includes creating a proxy task in a second schedule. The proxy task corresponds to and is a substantial copy of the first task. The method includes storing the second schedule.

The method can include creating a dependency between a second task in the second schedule and the proxy task in the second schedule.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same it should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIGS. 2A and 2B illustrate proxy tasks and cross-schedule dependencies behavior in accordance with disclosed embodiments; and

FIGS. 3 and 4 depict flowcharts of processes in accordance with disclosed embodiments.

### DETAILED DESCRIPTION

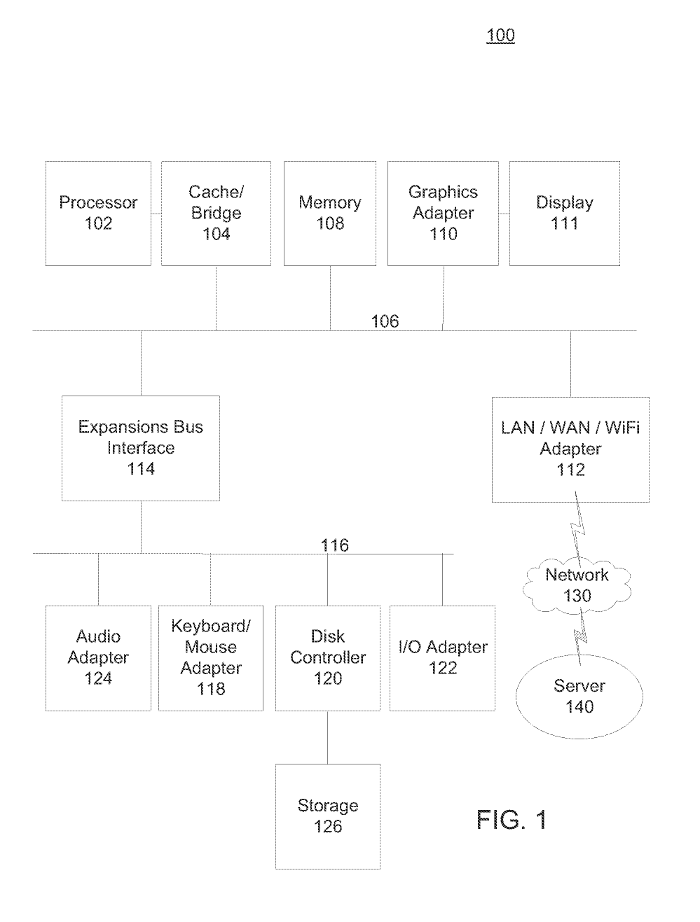

FIGS. 1 through 4, the other figures herein and attached hereto, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

PDM systems and other systems require a way to create dependencies between tasks that reside in various schedules or between different schedules. This can entail requiring a master schedule that brings in both the schedules together as a “master schedule” and a “sub-schedule” to enable creating dependencies. Such cases also require both the schedules to be loaded at the same time to maintain data integrity. It is also very important that proper security access rules are adhered to while opening a schedule that contains cross schedule dependency. For example, if a Schedule A has a cross-schedule dependency to a Schedule B, and a user who has access only to Schedule A opens Schedule A, the user should be able to determine that there is a cross schedule dependency. However, the user cannot access or view any data in Schedule B.

Working with multiple schedules and having the need to create and work with cross-schedule dependencies can be an issue with customers using PDM systems. Requiring a master schedule as a pre-requisite or needing to load both the schedules to create a cross schedule dependency is too restrictive.

Disclosed embodiments include systems and methods for using proxy tasks for creation of cross schedule dependencies without regard to the need of a master schedule or the need for both the schedules to be loaded simultaneously during creation. Various embodiments disclosed herein support these operations in a source-independent manner, working equally well on schedules both independent and part of a master schedule.

Disclosed embodiments also maintain security access while opening or working with a schedule that has a dependency to another. For example, if a user cannot view the other schedule, then the system maintains that restriction. Similarly, if a user has only “view” access to the second schedule, but has “edit” access to the first schedule, then various embodiments disclosed herein can ensure that any changes they make in the first schedule do not modify the data of the second schedule. As such, systems and methods disclosed herein are well-suited to environments that require adherence to security.

FIG. 1 depicts a Hock diagram of a data processing system in which an embodiment can be implemented, including as a PDM system particularly configured to perform processes as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can he any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Various embodiments described herein include systems and methods that can use “proxy tasks” to create and represent cross schedule dependencies. These proxy tasks can be used to create cross schedule dependencies, and can also be used and placed anywhere within a schedule where it is meaningful.

As used herein, a “proxy task” is a representation of a task in a different schedule. It is used as a reference to a task outside the current schedule. It mirrors some or all of the attributes of the task or tasks represented in the other schedule to which the user has access. The proxy task can be used to represent a task, a milestone, a summary task or even an entire schedule. A proxy task enables users to mirror the task in another schedule and create cross schedule dependencies to it.

Various embodiments include specific characteristics of proxy tasks and their use in creation of cross-schedule dependencies. When a cross-schedule dependency is created between two tasks in different schedules, the system can create two proxy tasks, one corresponding to each schedule, and can also create the dependencies between the appropriate task and proxy tasks to indicate cross-schedule dependency.

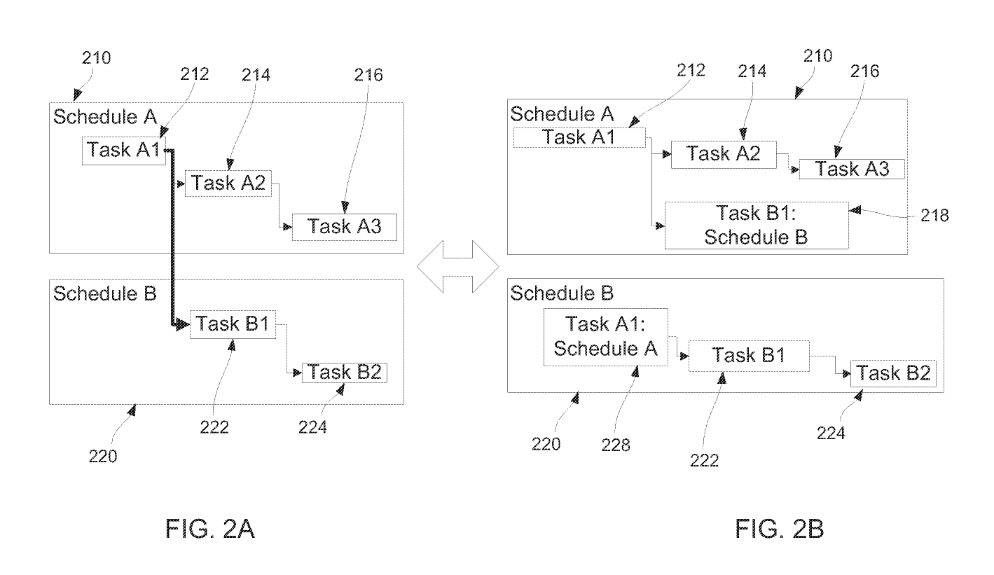

FIGS. 2A and 2B illustrate proxy tasks and cross-schedule dependencies behavior in accordance with disclosed embodiments. These figures show a first schedule, Schedule A 210, and a second schedule, Schedule B 220.

FIG. 2A shows that Schedule A 210 includes a Task A1 212, Task A2 214, and Task A3 216. FIG. 2A also shows that Schedule B 220 includes a Task B1 222 and Task B2 224. The arrows indicate a dependency relationship between these tasks.

In the FIG. 2A, the bold arrow line indicates a cross-schedule dependency between Task A1 212 and Task B1 222 in different schedules, Schedule A 210 and Schedule B 220. In a conventional system, such cross-schedule dependencies cause a number of problems as described above.

FIG. 2B shows that Schedule A 210 includes a Task A1 212, Task A2 214, and Task A3 216. FIG. 2B also shows that Schedule B 220 includes a Task B1 222 and Task B2 224. The arrows indicate a dependency relationship between these tasks.

FIG. 2B illustrates that when a cross-schedule dependency is created, in accordance with disclosed embodiments, no direct cross-schedule dependency is represented as in FIG. 2A. Instead, the system creates two proxy tasks that reference the other schedule and task. In the example of FIG. 2B, ProxyTask B1 218 is created in Schedule A 210, that points to “Task B1: Schedule B”. Similarly. ProxyTask A1 228 is created in Schedule B 220, that points to “Task A1: Schedule A”, When these dependencies to proxy tasks are created., the system also stores an indication that a cross schedule dependency is created. Of course “ProxyTask” is an arbitrary name used in this example for purposes of illustration, and does not limit the claimed embodiments.

Disclosed embodiments create and maintain proxy tasks as separate objects and use them for cross-schedule dependency; this can aid in maintaining cohesiveness by keeping tasks that belong to a schedule in that schedule instead of referencing a task in another schedule.

Disclosed embodiments also enable greater support for security access in terms of dis-allowing a change in one schedule to be automatically propagated to another schedule if the user does not have the required permissions to do so. Program and project managers can better manage the schedules they own by not having their schedule plans change without their knowledge. Various embodiments also provide support for schedule validation rules to maintain data integrity. This mechanism leverages and supports the various kinds of dependencies that need to be supported in a program/project management system, such as Finish to Start (FS), Start to Start (SS), Finish to Finish (FF), Start to Finish (SF), etc.

Proxy tasks can also include external tasks or objects in a different system. This allows the opening up of the system to create cross schedule dependency to not just another schedule, but to external objects.

In various embodiments, the system can interact with a user in multiple was to receive an input to create a proxy task. For example, the system can create a proxy task independently “from scratch” in response to a user pointing to the original task. The system can create a proxy task in response to a user using the system “clipboard” by selecting a normal task and using a “paste as proxy” input on a different schedule to easily create a proxy task.

The system can also create proxy tasks as “minors” of tasks or items in a master schedule. For example, a user will be able to mirror a task in the master schedule as a proxy task in all the sub schedules, and the system creates corresponding proxy tasks. One benefit of this approach is that it enables program or project managers to very easily replicate and represent key milestones from a master schedule to all the participating sub schedules.

For example, when the system receives a user input to create a cross-schedule dependency from within a master schedule, the system can create two proxy tasks internally in each of the different schedules. For example, in response to a cross-schedule dependency from Task A in Schedule A to Task B in Schedule B in FIG. 2B, the system can create two proxy tasks—a proxy task (such as ProxyTask B 218) in Schedule A that represents the real task B and another proxy task (such as ProxyTask A 228) in Schedule B that represents the real task A. This enables the system to provide visibility of a dependent task in another schedule.

Systems and methods disclosed herein to use proxy tasks for cross-schedule dependencies enable users to create cross-schedule dependencies without the need to have master schedules. This benefits program and project managers in particular since they can define a project plan with dependencies to any schedules internal or external and thus not restricted to master schedules.

Further, disclosed techniques can create cross-schedule dependency without the need for both the schedules to be loaded at the same time thus benefiting any performance considerations.

Various embodiments also allow various schedule validations to be run and adhered to without the need to load both the schedules. For example, if a first-schedule cross-schedule dependency needs to be changed to a second schedule, it allows for that without having the need for both the schedules to be loaded for validation thus benefiting performance reducing memory consumption.

Various embodiments provide different ways to create a cross schedule dependency, can create a cross-schedule dependency from a master schedule context, can create a dependency to or from a proxy task, can search for target tasks and create cross schedule dependencies, or can support different kinds of dependencies as described herein.

Proxy tasks can be created independently without dependencies as well. In those cases, it can mirror the attributes of the real task, and when the real task attributes change (e.g. the start dates, end dates, or any other attribute), the proxy task attributes can automatically reflect those changes. This can be important in cases where it is important for a plan to know the key drivers and milestones of a program being tracked in a master company plan.

The system can allow users to navigate from a proxy task to a real task, as well as relocate its position from one place to another in the structure without modifying the dates. This provides flexibility and easy navigability of proxy tasks.

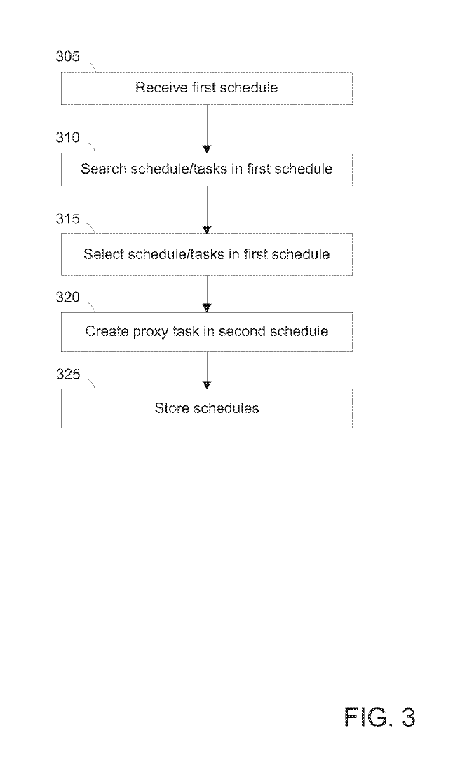

FIG. 3 depicts a process in accordance with disclosed embodiments that can be performed by one or more PLM systems. This process can be used to create a proxy task. In the processes described herein, the labels of “first schedule” and “second schedule” are arbitrary and used only to describe different schedules; these labels are not intended to be limiting.

The system receives a first schedule (step 305). “Receiving”, as used herein, can include loading from storage, receiving from another device or process, receiving via an interaction with a user, or otherwise. The first schedule has at least one task.

The system searches the first schedule for any tasks for which to make a proxy (step 310). In some cases, this can be a search for a specific task in the first schedule that is intended to have a dependency relationship with or otherwise correspond to a not-yet-created proxy task in a second schedule.

The system selects the task in the first schedule (step 315). This selection can be performed automatically in response to identifying the task as a result of the search, or can include displaying the results of the search to a user and receiving a user selection of the task in the first schedule that is intended to have a dependency relationship with or otherwise correspond to a not-yet-created proxy task in the second schedule.

The system creates a proxy task in a second schedule, corresponding to the selected task in the first schedule (step 320). The proxy task can include information referencing the selected task in the first schedule, and the selected task in the first schedule can include information referencing the proxy task in the second schedule. The system can create and maintain dependency relationships between the proxy task and the selected task in the first schedule or in the second schedule. The proxy task can be a substantial duplicate of the selected task, meaning that it can include the same task data such as start, finish, work complete, constraint, status, etc.

The system stores the second schedule (step 325). As part of this step, the system can also store the first schedule.

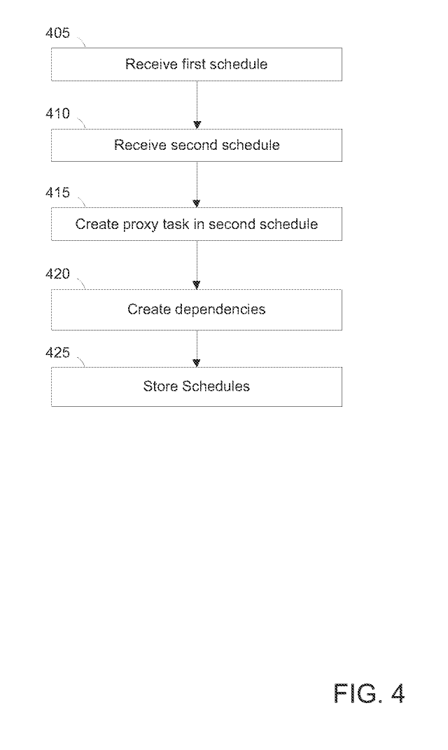

FIG. 4 depicts a process in accordance with disclosed embodiments that can be performed by one or more PLM systems. This process can be used to create a proxy task with dependencies.

The system receives a first schedule (step 405). The first schedule has at least one task. This schedule can be a master schedule.

The system receives at least one second schedule (step 410). In some cases, this can be one or more sub-schedules of the master schedule. For clarity of illustration, the second schedule will be referred to in the singular, but is not so limited.

The system creates a proxy task in the second schedule corresponding to the task in the first schedule (step 415). In some cases, this can be performed in response to receiving a user input, such as by the user “dragging” the task in the first schedule and “dropping” it into the second schedule. The proxy task can include information referencing the task in the first schedule, and the task in the first schedule can include information referencing the proxy task.

The system can create and maintain dependency relationships between the proxy task and the task in the first schedule (step 420). As part of this step, the system can automatically detect any changes in the task in the first schedule and make corresponding changes to the proxy task. The system can also maintain dependencies between the proxy task (in the second schedule) and other tasks in the second schedule. In those cases, the system can perform a plurality of processes to detect any changes in the task in the first schedule, make corresponding changes to the proxy task in the second schedule, then also make corresponding changes to any other tasks in the second schedule that are dependent on the proxy task.

Note that in some cases, where there may be a “two way” dependency between the task in the first schedule and the tasks in the second schedule, where a task in the first schedule is dependent on a task in the second schedule, and a task in the second schedule is dependent on a task in the first schedule. In such cases, the system can create respective proxy tasks in both the first and second schedules, so that the dependency for each task in each schedule is to the proxy task in that same schedule, and the proxy tasks in each schedule can be updated according to changes in a corresponding task in the other schedule.

The system stores the second schedule (step 425). As part of this step, the system can also store the first schedule.

Note that creating a proxy task does not necessarily automatically create dependencies or require creation of dependencies. In certain embodiments, the system can automatically create proxy tasks in response to a user creating cross schedule dependencies.

Unless otherwise described, the various processes, actions, and steps described above can be performed concurrently, sequentially, in a different order, or omitted in various embodiments. Various elements and steps described above can be combined differently or alternatively in other embodiments.

According to various embodiments, cross-schedule dependencies can be created between any schedules in the system using proxy tasks. Proxy tasks do not require a master schedule to create cross schedule dependencies, and does not require loading of both the schedules in its entirety to create cross schedule dependency. A proxy task can represent any type of task, milestone, phase, gate, schedule, or other event or object in the system, all referred to generically herein as “tasks”. Proxy tasks can also be used to “minor” tasks in sub-schedules from a master schedule. The system maintains security access rights of each task and their schedule including proxy tasks. The system can maintain corresponding drawing representations, for example, for a milestone proxy or a summary proxy.

In some embodiments, the system does not allow proxy tasks to be moved or edited directly, but instead they reflect the dates and attribute changes according to the “home” or original task. Proxy tasks can exist without a cross-schedule dependency existing.

Various embodiments include other PDM systems, methods, and mediums. For example, another method includes receiving a first schedule that includes at least a first task. The method includes creating a proxy task in a second schedule or in the same schedule. The proxy task corresponds to and is a substantial copy of the first task. The method includes creating a relation between the proxy task and the original task and creating a dependency between a proxy task and a normal schedule task. The method can include storing both the first and second schedule.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

1. A method performed by a product data management (PDM) data processing system, comprising:
receiving a first schedule in the PDM data processing system, the first schedule including at least a first task;
creating a proxy task in a second schedule by the PDM data processing system, the proxy task corresponding to and being a substantial copy of the first task and including a pointer to the first schedule and the first task;
automatically and selectively propagating a change in the proxy task to the first task based on user permissions; and
storing the second schedule in the PDM data processing system.

2. The method of claim 1, wherein the PDM data processing system also creates a dependency between a second task in the second schedule and the proxy task in the second schedule.

3. The method of claim 1, wherein the PDM data processing system also creates a dependency between the proxy task and a second task in the second schedule.

4. The method of claim 1, wherein the proxy task is created in response to receiving a user input.

5. The method of claim 1, wherein the proxy task is created in response to receiving a user dragging the first task from the first schedule and dropping it into the second schedule.

6. The method of claim 1, wherein the first schedule is a master schedule and the second schedule is one of a plurality of sub-schedules.

7. The method of claim 1, wherein the second schedule is stored along with information referencing the first task.

8. A product data management (PDM) data processing system, comprising:
at least one processor; and
an accessible memory, wherein the PDM data processing system is configured to receive a first schedule, the first schedule including at least a first task;
create a proxy task in a second schedule, the proxy task corresponding to and being a substantial copy of the first task and including a pointer to the first schedule and the first task;
automatically and selectively propagate a change in the proxy task to the first task based on user permissions; and
store the second schedule.

9. The PDM data processing system of claim 8, further configured to create a dependency between a second task in the second schedule and the proxy task in the second schedule.

10. The PDM data processing system of claim 8, further configured to create a dependency between the proxy task and a second task in the second schedule.

11. The PDM data processing system of claim 8, wherein the proxy task is created in response to receiving a user input.

12. The PDM data processing system of claim 8, wherein the proxy task is created in response to receiving a user dragging the first task from the first schedule and dropping it into the second schedule.

13. The PDM data processing system of claim 8, wherein the first schedule is a master schedule and the second schedule is one of a plurality of sub-schedules.

14. The PDM data processing system of claim 8, wherein the second schedule is stored along with information referencing the first task.

15. A non-transitory computer-readable medium encoded with executable instructions that, when executed, cause a product data management (PDM) data processing system to:
receive a first schedule, the first schedule including at least a first task;
create a proxy task in a second schedule, the proxy task corresponding to and being a substantial copy of the first task and including a pointer to the first schedule and the first task;
automatically and selectively propagate a change in the proxy task to the first task based on user permissions; and
store the second schedule.

16. The computer-readable medium of claim 15, wherein the instructions cause the PDM data processing system to create a dependency between a second task in the second schedule and the proxy task in the second schedule.

17. The computer-readable medium of claim 15, wherein the instructions cause the PDM data processing system to create a dependency between the proxy task and a second task in the second schedule.

18. The computer-readable medium of claim 15, wherein the proxy task is created in response to receiving a user input.

19. The computer-readable medium of claim 15, wherein the proxy task is created in response to receiving a user dragging the first task from the first schedule and dropping it into the second schedule.

20. The computer-readable medium of claim 15, wherein the first schedule is a master schedule and the second schedule is one of a plurality of sub-schedules.

21. The computer-readable medium of claim 15, wherein the second schedule is stored along with information referencing the first task.
